(19) United States
(12) Patent Application Publication
(10) Pub. No.: US 2024/0168046 A1
(43) Pub. Date: May 23, 2024

(54) SYSTEMS AND METHODS FOR HUMIDITY AND/OR TEMPERATURE CONTROL IN A SAMPLE ANALYSIS SYSTEM

(71) Applicant: DH TECHNOLOGIES DEVELOPMENT PTE. LTD., Singapore (SG)

(72) Inventors: Thomas R. Covey, Concord (CA); Chang Liu, Concord (CA)

(21) Appl. No.: 18/283,367

(22) PCT Filed: Mar. 21, 2022
(86) PCT No.: PCT/IB2022/052565

§ 371 Date: Sep. 21, 2023

Related U.S. Application Data
(60) Provisional application No. 63/164,869, filed on Mar. 23, 2021.

(51) Int. Cl. G01N 35/10; G01N 35/00

(52) U.S. Cl. CPC G01N 35/10; G01N 2035/00386; G01N 2035/00455; G01N 2035/1034

(57) ABSTRACT

GT Systems and methods are disclosed for controlling humidity and/or temperature during chemical analysis of a sample material. Specifically, the present application relates to microfluidics systems and methods, e.g. involving ADE, open port interface (OPI) and/or mass spectrometry (MS), for controlling humidity and/or temperature during chemical analysis of a sample material. The present systems and methods allow a user to modify the temperature of a microplate during dispensing. This allows the user to study reactions that occur at temperatures different than room temperature, e.g. at body temperature. Additionally, modifying and/or controlling the temperature of a microplate during dispensing can allow a user to maintain quality of a sample through maintaining a proper temperature, e.g. a cool temperature to prevent degradation of a sample. As part of the present invention, Applicant determined how to avoid phase changes, e.g. evaporation, that are particularly concerning because of the small amounts of sample involved.

### CROSS-REFERENCE TO RELATED APPLICATIONS

This application claims is related to, and claims the benefit of priority from U.S. Provisional patent application Ser. No. 63/164,869, filed Mar. 23, 2021, and which is incorporated by reference herein in its entirety.

### BACKGROUND

Microfluidic dispensing pertains to the control and manipulation of fluids to extract a small volume of fluid from a bulk fluid sample for examination. Microfluidic dispensing emerged in the early 1980s and has been used in a diverse range of fields such as inkjet printing, DNA microarrays, lab-on-a-chip technology, 3-D printing heads, microtiter plate replication and reformatting of pharmaceutical drug libraries, dispensing of individual cells and cell lysates, among other fields.

Microfluidic dispensing has continued to grow and evolve and now is capable of dispensing smaller and smaller volumes of fluids, often via methods that deliver highly precise volumes via non-contact methods. Microfluidic dispensing is particularly useful in fields where reagents are costly or available in limited quantities as well as applications where high speed and throughput is desirable. By way of example, drug development and discovery including high throughput screening (HTS) and the characterization of the pharmacologically relevant administration/distribution/metabolism/excretion (ADME) properties have embraced microfluidic dispensing for these reasons as have fields related to next-generation gene sequencing. More recently the inventors have been incorporating microfluidic dispensing technology to introduce samples to analytical measurement tools such as mass spectrometers.

The basic operation of microfluidic dispensing involves the separation of a small volume of sample material from a relatively larger “bulk” sample. The sample material may be dispensed in different forms, for instance, as a single discrete droplet, group of droplets, mist, or other physical arrangement of the sample material. Depending upon the specific mechanism used to separate the sample material different dispensed forms may be more or less reproducible with each dispensation.

Dispensation by droplet, for instance, has been used to dispense discrete droplets as small as the picoliter range. Some of the most common types of systems for delivering low volume droplets from samples are broadly characterized as jetting or dynamic devices, examples include, for instance: acoustic technology; piezoelectric technology; pressure-driven technology; air-driven pump/valve technology; electric field driven technology; etc. These dispensation devices all transfer a measured amount of energy that is directed into the bulk sample in order to break a desired sample volume from the bulk sample fluid in the form of a droplet or droplets.

Acoustic droplet dispensing is commercially used for transferring liquid samples from one microtiter plate to another, so called plate replication and reformatting. Dispensers are also being developed to transfer samples from test tubes of various configurations into microtiter plates or microplates. The inventors are using acoustic droplet dispensing to direct samples of controlled volume into a capture probe for collection and transfer for mass analysis by a mass spectrometer.

As an example of liquid dispensing, acoustic droplet ejection (ADE) is a technique used to transfer, contact free, volumetrically accurate and precise droplets from sample wells in a microtiter plate to a corresponding sample well in a second microtiter plate. The use of energy in the form of sound waves allows for the transfer of fluids in the form of discrete droplets to be contact free, volumetrically accurate, and precise when conditions are highly controlled.

Multiple droplets can be sequentially dispensed to a target well to accumulate to reach a desired dispensing volume. Pharmaceutical research and development organizations use this method extensively to dispense small volumes of compounds, typically dissolved in dimethyl sulfoxide, from their large drug libraries to be further tested in HTS assays screening for biological activity and ADME assays determining pharmacological properties. In some instances, there is a requirement of repeated ejection from the same sample well from different time points, for example for monitoring the reaction process.

In some instances, it may be desirable to modify the temperature of a microplate during dispensing. For example, there are reactions that occur at temperatures different than room temperature, e.g. at around body temperature or 37° C. As a specific example, in drug discovery, many reactions are investigated at around body temperature or 37° C. Modifying the temperature of a microplate allows a user to study such reactions. Additionally, modifying and/or controlling the temperature of a microplate during dispensing can allow a user to maintain quality of a sample through maintaining a proper temperature, e.g. a cool temperature to prevent degradation of a sample.

However, prior dispensing systems, e.g. prior ADE systems, only provide the dispensing environment at room temperature and do not include functionality to control temperature within the microplate/microfluidic dispensing system. One particular challenge in modifying temperature in a microplate/microfluidic dispensing system is avoiding phase changes, e.g. evaporation, during temperature changes. Such phase changes are particularly concerning because of the small amounts of sample involved.

### BRIEF DESCRIPTION OF THE DRAWINGS

FIG. 1 illustrates a system comprising a temperature and humidity control component according to embodiments of the present disclosure.

FIGS. 2A-B illustrate an open port interface (OPI) sampling interface and an acoustic droplet ejection (ADE) device in accordance with some example aspects and embodiments of the disclosure.

FIG. 3 illustrates a top down view of an embodiment of the present systems/methods incorporating a slip cover.

FIG. 4 illustrates a cross sectional side view of an embodiment of the present systems/methods incorporating a slip cover during testing of a first and second well.

### SUMMARY

Various aspects of this disclosure provide systems and methods for controlling humidity and/or temperature during chemical analysis of a sample material. Specifically, the present application relates to systems and methods, e.g. involving ADE, open port interface (OPI) and/or mass spectrometry (MS), for controlling humidity and/or temperature during chemical analysis of a sample material. The present systems and methods allow a user to modify the temperature of a microplate during dispensing. This allows the user to study reactions that occur at temperatures different than room temperature, e.g. at body temperature. Additionally, modifying and/or controlling the temperature of a microplate during dispensing can allow a user to maintain quality of a sample through maintaining a proper temperature, e.g. a cool temperature to prevent degradation of a sample.

In one embodiment the present system for chemical analysis of a sample material comprises a sample delivery system, a sample microplate, a chemical analyzing component, and a temperature and humidity control component.

In some embodiments, the sample delivery system comprises an acoustic droplet ejection system. In some embodiments, the sample delivery system further comprises an open port interface.

In some embodiments, the system comprises a high throughput screening system, a microfluidics system and/or a micro-electromechanical system.

In some embodiments, the chemical analyzing component comprises a chromatography instrument, a mass spectrometer, an ultraviolet-visible spectrometer, a near-infrared spectrometer and/or a fluorescence/illumination detection instrument.

In some embodiments, the temperature and humidity control component comprises a flow of gas. For example, the temperature and humidity control component can be a blower that produces a top down curtain of gas. As another example, the gas can be at a temperature of above 37° C.

The temperature and humidity control component can control at least one of the flow rate, temperature, humidity and/or atmospheric composition of the gas.

In some embodiments, the system allows for same-well reaction monitoring of in-situ kinetics.

In some embodiments, the system further comprises a slip cover having a hole covering the microplate and a movable stage under the microplate.

In another embodiment, the present method for analyzing a sample material comprises the steps of providing a sample to a sample plate via a sample delivery device, performing chemical analysis on a sample from the sample plate, and controlling temperature and humidity during sample delivery and chemical analysis.

In some embodiments, the sample delivery device comprises an acoustic droplet ejection system. In some embodiments, the method further comprises capturing and delivering the sample using an open port interface.

In some embodiments, the method is high throughput screening.

In some embodiments, the chemical analysis is chromatography, mass spectrometry, ultraviolet-visible spectrometry, near-infrared spectrometry and/or fluorescence/illumination detection.

In some embodiments, the temperature and humidity is controlled using a flow of gas. For example, the temperature and humidity control component can be controlled by a blower that produces a top down curtain of gas. As another example, the gas can be at a temperature of above 37° C.

The temperature and humidity can by controlled using at least one of the flow rate, temperature, humidity and/or atmospheric composition of the gas.

In some embodiments, the method allows for same-well reaction monitoring of in-situ kinetics.

In some embodiments, the method further comprises covering the microplate with a slip cover having a hole and moving the microplate to align the hole with a well being analyzed.

In another embodiment, the present temperature and humidity control component for use in analyzing a sample material, comprises a blower for producing a top down curtain of humidified gas at a temperature of greater than 37° C.

### DETAILED DESCRIPTION

The present application relates to systems and methods for controlling humidity and/or temperature during chemical analysis of a sample material. Specifically, the present application relates to microfluidics systems and methods, e.g. involving ADE (acoustic droplet ejection), open port interface (OPI) and/or mass spectrometry (MS), for controlling humidity and/or temperature during chemical analysis of a sample material. The present systems and methods allow a user to modify the temperature of a microplate during dispensing. This allows the user to study reactions that occur at temperatures different than room temperature, e.g. at body temperature. Additionally, modifying and/or controlling the temperature of a microplate during dispensing can allow a user to maintain quality of a sample through maintaining a proper temperature, e.g. a cool temperature to prevent degradation of a sample. In accordance with the aspects and embodiment of the disclosure, are provided systems and methods that have been developed and adapted to avoid phase changes, e.g. evaporation, that are particularly concerning because of the small amounts of sample involved.

The present systems and methods, e.g. involving ADE, OPI and/or MS with temperature and/or humidity control, have several unique advantages over conventional methods, e.g. liquid chromatography-mass spectrometry (LC-MS) or plate-reader based systems. Such advantages include non-contact small-volume sampling, high readout speed, good reproducibility and tolerance to complex matrix.

In accordance with aspect and embodiments of the systems and methods, the disclosure demonstrates same-well reaction monitoring for in-situ kinetics. The same incubation well can be sampled at multiple time points while the reaction is occurring with time intervals as small as several seconds. This in-situ kinetics workflow can significantly improve data quality and reduce reagent cost compared with conventional “quenching” methods based on multiple plates (one quenched plate represents a single time point). Such in situ testing may be made possible, at least in part, by Applicant's enabling of temperature and humidity control (to reduce phase change, e.g. evaporation at higher temperatures).

In one embodiment the present system for chemical analysis of a sample material comprises a sample delivery system, a sample microplate, a chemical analyzing component and a temperature and humidity control component. In one embodiment, the present method for analyzing a sample material comprises the steps of: providing a sample to a sample plate via a sample delivery device; performing chemical analysis on a sample from the sample plate; and controlling temperature and humidity during sample delivery and chemical analysis. In some examples, the systems and methods can be high throughput screening, microfluidics and/or a micro-electromechanical.

The temperature and humidity control component can raise, lower or maintain the temperature of a sample in the system while simultaneously raising, lowering or maintaining the humidity in system. For example, the temperature and humidity control component can raise, lower or maintain the temperature of a sample in the sample microplate, the sample delivery system, and/or the chemical analyzing component while simultaneously raising, lowering or maintaining the humidity in any of those places. For example, the temperature and humidity control component can comprise a flow of gas. Specifically, the temperature and humidity control component can use a temperature controlled, humidified gas. In one embodiment, the temperature and humidity control component is a blower that produces a curtain of gas, e.g. a top down curtain of gas.

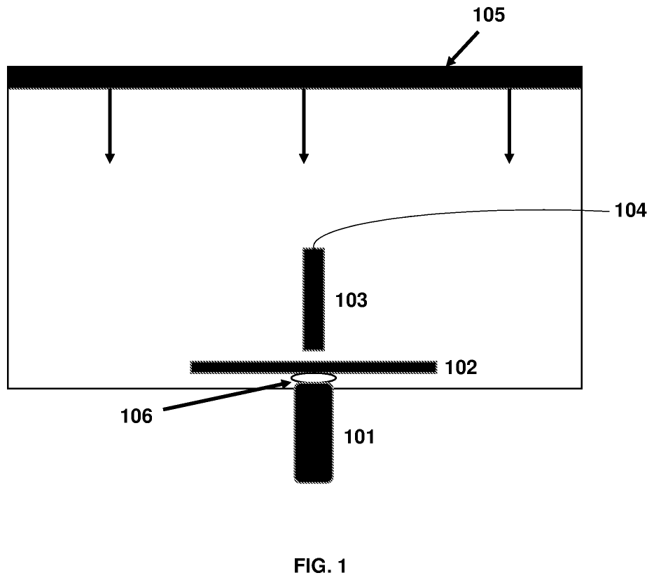

FIG. 1 shows a system comprising a temperature and humidity control component according to embodiments of the present invention. FIG. 1 shows an exemplary sample delivery system (an ADE and OPI in this example) 101 and 103, a sample microplate 102, a chemical analyzing component (MS in this example) 104 and a temperature and humidity control component 105. In this embodiment, the temperature and humidity control component 105 is shown as top-down curtain of heated/cooled and humidified air. The top-down curtain gas of heated/cooled and humidified air helps the control of the temperature and humidity of the sample in the sample delivery system 101/103, sample microplate 102, and/or chemical analyzing component 104. The heated/cooled air with high humidity can be used to create a local environment surrounding the sample plate for controlling (i.e. raising, lowering or maintaining) the temperature and reducing phase change, e.g. evaporation, of the sample.

FIG. 1 shows the system including an optional microplate heating/cooling component (a coupling fluid in this example) 106. The temperature control of the sample plate can be further assisted by the microplate heating/cooling component 106, i.e. the heated coupling fluid that directly heats/cools the microplate.

Other optional components could additionally be added to the present system. For example, an enclosure for the entire system (not shown) could be added to further assist in local environment maintenance.

The temperature and humidity control component can accomplish the desired raising, lowering or maintaining the temperature of a sample in the system while simultaneously raising, lowering or maintaining the humidity in system by controlling at least one of the flow rate, temperature, humidity and/or atmospheric composition of the flowing gas.

In some embodiments the temperature and humidity control component raises the temperature of a sample in the system above room temperature while simultaneously raising, lowering or maintaining the humidity in system. For example, this can occur in the sample microplate, the sample delivery system, and/or the chemical analyzing component. In some embodiments the temperature and humidity control component heats the sample in the system to 30-80° C., preferably 37-40° C., most preferably 39° C. This can be done using a curtain of air at a temperature of 30-80° C., preferably 37-40° C., most preferably 39° C. In a preferred embodiment, the temperature and humidity control component simultaneously maintains or raises the humidity at increased temperatures. In a most preferred system, the temperature and humidity control component simultaneously raises the humidity at increased temperatures. In some embodiments, the high-humidity air can be controlled at a similar temperature as the sample plate, so that the water vapor does not condense in the well.

Embodiments of the present invention where the temperature and humidity control component raises the temperature of a sample in the system above room temperature while simultaneously raising, lowering or maintaining the humidity in system allow for same-well reaction monitoring of in-situ kinetics. In some embodiments, such embodiments enable ADE-OPP analysis for in-situ kinetics. Such embodiments allow the user to run the reaction in a particular well or wells and periodically use the acoustic device to eject droplets from the well for the purpose of monitoring the reaction kinetics. Since many reactions of interest in drug discovery require higher temperature (e.g. body temperature of 37° C.), this is particularly valuable. The combination of controlling temperature and humidity helps with problems associated with evaporation from the sample well.

In some embodiments the temperature and humidity control component lowers the temperature of a sample in the system below room temperature while simultaneously raising, lowering or maintaining the humidity in system. For example, this can occur in the sample microplate, the sample delivery system, and/or the chemical analyzing component. In some embodiments the temperature and humidity control component cools the sample in the system to 4-20° C., preferably 4-10° C., most preferably 4° C. This can be done using a curtain of air at a temperature of 4-20° C., preferably 4-10° C., most preferably 4° C. Such embodiments may be beneficial in maintaining stability and/or quality of biological samples.

In some embodiments the temperature and humidity control component includes a thermometer and/or hygrometer for measuring temperature and/or humidity within the system. The optional thermometer and/or hygrometer allows for adjustment of the temperature and/or humidity in an upward or downward direction based on measured values.

The temperature and humidity control component can also raise, lower or maintain the humidity in the system. For example, the temperature and humidity control component can raise, lower or maintain the humidity in the sample microplate, the sample delivery system, and/or the chemical analyzing component. In some embodiments, the temperature and humidity control component creates a humidity level sufficient to avoid significant evaporation of the samples and below the dew point of the atmosphere. In some embodiments, the temperature and humidity control component creates a humidity level of 50-90% humidity, alternatively 50-80% humidity, alternatively 50-70% humidity. This can be done using a curtain of air at a humidity level of 50-90% humidity, alternatively 50-80% humidity, alternatively 50-70% humidity. In a preferred embodiment, the temperature and humidity control component simultaneously maintains or raises the humidity at increased temperatures. In a most preferred system, the temperature and humidity control component simultaneously raises the humidity at increased temperatures. In some embodiments, the high-humidity air can be controlled at a similar temperature as the sample plate, so that the water vapor does not condense in the well.

The temperature and humidity control component can also control the flow rate of the gas. In some embodiments, the flow rate of the gas is slightly greater than the outside atmosphere. In some embodiments, the flow rate maintains a slight positive pressure. In some embodiments, the flow rate is low enough that it does not affect the trajectory of the droplet dispensed from the ADE. An additional benefit of the design shown in FIG. 1 is that the flowing air does not affect the trajectory of the droplet dispensed from the ADE, due in part to the protection provided by the OPI device from above.

The temperature and humidity control component can also control the atmospheric composition of the gas. In some embodiments, the gas can be atmospheric. In other embodiments the gas comprises an inert gas or combination of inert gases, e.g. nobel gases, argon, carbon dioxide, helium, nitrogen, etc.

The microplate is a fluid containers widely used in chemical and biomedical research and development. Such microplates commonly have 96, 384, and/or 1536 wells, although other numbers of wells are also in use. The dimensions and other characteristics of microplates have been standardized by the Society for Biomolecular Screening. A common size of microplate is 127.76 by 85.48 by 14.35 mm. Microplates are commonly designed to be stacked on top of each other in storage. Other fluid containment vessels could be used in the present systems and methods, e.g. microtubes. Microtubes are commonly used in racks of 96 or 384. These racks of microtubes conform to dimensions similar to the length and width of well plates so they can be handled by similar robotic and automation equipment.

The sample delivery system removes small volume of sample material from a relatively larger “bulk” sample and dispenses them into a different location, e.g. a microplate. Numerous known sample delivery systems can effectively be used in the present systems and methods. In one embodiment, the sample delivery system comprises an acoustic droplet ejection (ADE) system. The chemical analyzing component performs analysis on the small samples removed from the bulk material. Numerous known chemical analyzing components can effectively be used in the present systems and methods. For example, the chemical analyzing component can comprise a chromatography instrument, a mass spectrometer, a ultraviolet-visible spectrometer, a near-infrared spectrometer and/or a fluorescence/illumination detection instrument.

In some embodiments, an additional component of the sample delivery system is also included. The proper sampling of sample materials and preparation of such materials for further chemical analysis can present challenges. In the case of mass spectrometry and high performance liquid chromatography, for example, the sample must be properly placed into solution prior to entering the analysis device. The sample material can be received in diverse forms such as particulates ejected from a solid sample surface by laser or acoustic ablation, as a solid from puncture sampling devices such as pins, from droplets of sample-bearing solution, from liquid extraction from a surface, and the like. These sample specimens must be processed into an appropriate solution prior to further chemical analysis. In an embodiment, the additional component of the sample delivery system comprises an open port interface (OPI).

In some embodiments, the blowing of the gas from the temperature and humidity control component may potentially interfere the trajectory of the droplet dispensing from the sample well to the OPI. In order to address this, the OPI itself may have a protective component incorporate therein. The protective component may act a physical barrier to prevent interference with the trajectory of the droplet dispensing from the sample well to the OPI.

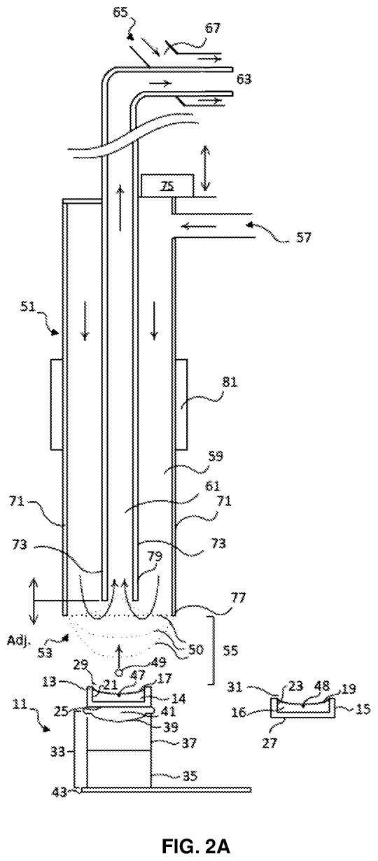

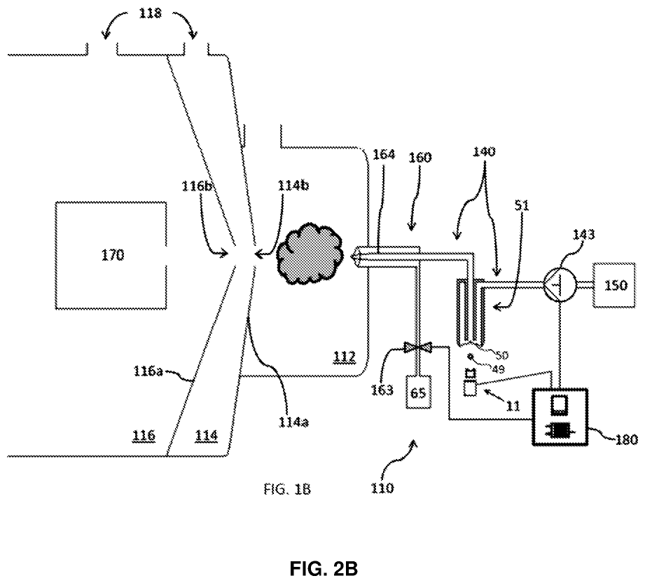

A representative sample delivery system and chemical analyzing component in accordance with example aspects and embodiments of the disclosure is illustrated in FIGS. 2A-B. As with all figures referenced herein, in which like parts are referenced by like numerals, FIG. 2A is not to scale, and certain dimensions are exaggerated for clarity of presentation. In FIG. 2A, the acoustic droplet ejection (ADE) device is shown generally at 11, ejecting droplet 49 toward the continuous flow sampling probe (referred to herein as an open port interface (OPI)) indicated generally at 51 and into the sampling tip 53 thereof.

The acoustic droplet ejection device 11 includes at least one reservoir, with a first reservoir shown at 13 and an optional second reservoir 31. In some embodiments a further plurality of reservoirs may be provided. Each reservoir is configured to house a fluid sample having a fluid surface, e.g., a first fluid sample 14 and a second fluid sample 16 having fluid surfaces respectively indicated at 17 and 19. When more than one reservoir is used, as illustrated in FIG. 2A, the reservoirs are preferably both substantially identical and substantially acoustically indistinguishable, although identical construction is not a requirement.

The ADE comprises acoustic ejector 33, which includes acoustic radiation generator 35 and focusing means 37 for focusing the acoustic radiation generated at a focal point 47 within the fluid sample, near the fluid surface. As shown in FIG. 2A, the focusing means 37 may comprise a single solid piece having a concave surface 39 for focusing the acoustic radiation, but the focusing means may be constructed in other ways as discussed below. The acoustic ejector 33 is thus adapted to generate and focus acoustic radiation so as to eject a droplet of fluid from each of the fluid surfaces 17 and 19 when acoustically coupled to reservoirs 13 and 15, and thus to fluids 14 and 16, respectively. The acoustic radiation generator 35 and the focusing means 37 may function as a single unit controlled by a single controller, or they may be independently controlled, depending on the desired performance of the device.

The acoustic droplet ejector 33 may be in either direct contact or indirect contact with the external surface of each reservoir. With direct contact, in order to acoustically couple the ejector to a reservoir, it is preferred that the direct contact be wholly conformal to ensure efficient acoustic energy transfer. That is, the ejector and the reservoir should have corresponding surfaces adapted for mating contact. Thus, if acoustic coupling is achieved between the ejector and reservoir through the focusing means, it is desirable for the reservoir to have an outside surface that corresponds to the surface profile of the focusing means. Without conformal contact, efficiency and accuracy of acoustic energy transfer may be compromised. In addition, since many focusing means have a curved surface, the direct contact approach may necessitate the use of reservoirs that have a specially formed inverse surface.

Optimally, acoustic coupling is achieved between the ejector and each of the reservoirs through indirect contact, as illustrated in FIG. 2A. In the figure, an acoustic coupling medium 41 is placed between the ejector 33 and the base 25 of reservoir 13, with the ejector and reservoir located at a predetermined distance from each other. The acoustic coupling medium may be an acoustic coupling fluid, preferably an acoustically homogeneous material in conformal contact with both the acoustic focusing means 37 and the underside of the reservoir. In addition, it is important to ensure that the fluid medium is substantially free of material having different acoustic properties than the fluid medium itself. As shown, the first reservoir 13 is acoustically coupled to the acoustic focusing means 37 such that an acoustic wave generated by the acoustic radiation generator is directed by the focusing means 37 into the acoustic coupling medium 41, which then transmits the acoustic radiation into the reservoir 13.

In operation, reservoir 13 and optional reservoir 15 of the device are filled with first and second fluid samples 14 and 16, respectively, as shown in FIG. 2A. The acoustic ejector 33 is positioned just below reservoir 13, with acoustic coupling between the ejector and the reservoir provided by means of acoustic coupling medium 41. Initially, the acoustic ejector is positioned directly below sampling tip 53 of OPI 51, such that the sampling tip faces the surface 17 of the fluid sample 14 in the reservoir 13. Once the ejector 33 and reservoir 13 are in proper alignment below sampling tip 53, the acoustic radiation generator 35 is activated to produce acoustic radiation that is directed by the focusing means 37 to a focal point 47 near the fluid surface 17 of the first reservoir. As a result, droplet 49 is ejected from the fluid surface 17 toward and into the liquid boundary 50 at the sampling tip 53 of the OPI 51, where it combines with solvent in the flow probe 53. The profile of the liquid boundary 50 at the sampling tip 53 may vary from extending beyond the sampling tip 53 to projecting inward into the OPI 51. In a multiple-reservoir system, the reservoir unit (not shown), e.g., a multi-well plate or tube rack, can then be repositioned relative to the acoustic ejector such that another reservoir is brought into alignment with the ejector and a droplet of the next fluid sample can be ejected. The solvent in the flow probe cycles through the probe continuously, minimizing or even eliminating “carryover” between droplet ejection events. Fluid samples 14 and 16 are samples of any fluid for which transfer to an analytical instrument is desired, where the term “fluid” is as defined earlier herein.

The structure of OPI 51 is also shown in FIG. 2A. Any number of commercially available continuous flow sampling probes can be used as is or in modified form, all of which, as is well known in the art, operate according to substantially the same principles. As can be seen in the FIG. 2A, the sampling tip 53 of OPI 51 is spaced apart from the fluid surface 17 in the reservoir 13, with a gap 55 therebetween. The gap 55 may be an air gap, or a gap of an inert gas, or it may comprise some other gaseous material; there is no liquid bridge connecting the sampling tip 53 to the fluid 14 in the reservoir 13. The OPI 51 includes a solvent inlet 57 for receiving solvent from a solvent source and a solvent transport capillary 59 for transporting the solvent flow from the solvent inlet 57 to the sampling tip 53, where the ejected droplet 49 of analyte-containing fluid sample 14 combines with the solvent to form an analyte-solvent dilution. A solvent pump (not shown) is operably connected to and in fluid communication with solvent inlet 57 in order to control the rate of solvent flow into the solvent transport capillary and thus the rate of solvent flow within the solvent transport capillary 59 as well.

Fluid flow within the OPI 51 carries the analyte-solvent dilution through a sample transport capillary 61 provided by inner capillary tube 73 toward sample outlet 63 for subsequent transfer to an analytical instrument. A sampling pump (not shown) can be provided that is operably connected to and in fluid communication with the sample transport capillary 61, to control the output rate from outlet 63. In a preferred embodiment, a positive displacement pump is used as the solvent pump, e.g., a peristaltic pump, and, instead of a sampling pump, an aspirating nebulization system is used so that the analyte-solvent dilution is drawn out of the sample outlet 63 by the Venturi effect caused by the flow of the nebulizing gas introduced from a nebulizing gas source 65 via gas inlet 67 (shown in simplified form in FIG. 2A, insofar as the features of aspirating nebulizers are well known in the art) as it flows over the outside of the sample outlet 63. The analyte-solvent dilution flow is then drawn upward through the sample transport capillary 61 by the pressure drop generated as the nebulizing gas passes over the sample outlet 63 and combines with the fluid exiting the sample transport capillary 61. A gas pressure regulator is used to control the rate of gas flow into the system via gas inlet 67. In a preferred manner, the nebulizing gas flows over the outside of the sample transport capillary 61 at or near the sample outlet 63 in a sheath flow type manner which draws the analyte-solvent dilution through the sample transport capillary 61 as it flows across the sample outlet 63 that causes aspiration at the sample outlet upon mixing with the nebulizer gas.

The solvent transport capillary 59 and sample transport capillary 61 are provided by outer capillary tube 71 and inner capillary tube 73 substantially co-axially disposed therein, where the inner capillary tube 73 defines the sample transport capillary, and the annular space between the inner capillary tube 73 and outer capillary tube 71 defines the solvent transport capillary 59.

The system can also include an adjuster 75 coupled to the outer capillary tube 71 and the inner capillary tube 73. The adjuster 75 can be adapted for moving the outer capillary tube tip 77 and the inner capillary tube tip 79 longitudinally relative to one another. The adjuster 75 can be any device capable of moving the outer capillary tube 71 relative to the inner capillary tube 73. Exemplary adjusters 75 can be motors including, but are not limited to, electric motors (e.g., AC motors, DC motors, electrostatic motors, servo motors, etc.), hydraulic motors, pneumatic motors, translational stages, and combinations thereof. As used herein, “longitudinally” refers to an axis that runs the length of the probe 51, and the inner and outer capillary tubes 73, 71 can be arranged coaxially around a longitudinal axis of the probe 51.

Additionally, as illustrated in FIG. 2A, the OPI 51 may be generally affixed within an approximately cylindrical holder 81, for stability and ease of handling.

FIG. 2B schematically depicts an embodiment of an exemplary system 110 in accordance with various aspects of the applicant's teachings for ionizing and mass analyzing analytes received within an open end of a sampling probe 51, the system 110 including an acoustic droplet injection device 11 configured to inject a droplet 49, from a reservoir into the open end of the sampling probe 51. As shown in FIG. 2B, the exemplary system 110 generally includes a sampling probe 51 (e.g., an open port probe) in fluid communication with a nebulizer-assisted ion source 160 for discharging a liquid containing one or more sample analytes (e.g., via electrospray electrode 164) into an ionization chamber 112, and a mass analyzer 170 in fluid communication with the ionization chamber 112 for downstream processing and/or detection of ions generated by the ion source 160. A fluid handling system 140 (e.g., including one or more pumps 143 and one or more conduits) provides for the flow of liquid from a solvent reservoir 150 to the sampling probe 51 and from the sampling probe 51 to the ion source 160. For example, as shown in FIG. 2B, the solvent reservoir 150 (e.g., containing a liquid, desorption solvent) can be fluidly coupled to the sampling probe 51 via a supply conduit through which the liquid can be delivered at a selected volumetric rate by the pump 143 (e.g., a reciprocating pump, a positive displacement pump such as a rotary, gear, plunger, piston, peristaltic, diaphragm pump, or other pump such as a gravity, impulse, pneumatic, electrokinetic, and centrifugal pump), all by way of non-limiting example. As discussed in detail below, flow of liquid into and out of the sampling probe 51 occurs within a sample space accessible at the open end such that one or more droplets can be introduced into the liquid boundary 50 at the sample tip 53 and subsequently delivered to the ion source 160. As shown, the system 110 includes an acoustic droplet injection device 11 that is configured to generate acoustic energy that is applied to a liquid contained with a reservoir (as depicted in FIG. 2A) that causes one or more droplets 49 to be ejected from the reservoir into the open end of the sampling probe 51. A controller 180 can be operatively coupled to the acoustic droplet injection device 11 and can be configured to operate any aspect of the acoustic droplet injection device 11 (e.g., focusing means, acoustic radiation generator, automation means for positioning one or more reservoirs into alignment with the acoustic radiation generator, etc.) so as to inject droplets into the sampling probe 51 or otherwise discussed herein substantially continuously or for selected portions of an experimental protocol by way of non-limiting example.

As shown in FIG. 2B, the exemplary ion source 160 can include a source 65 of pressurized gas (e.g. nitrogen, air, or a noble gas) that supplies a high velocity nebulizing gas flow which surrounds the outlet end of the electrospray electrode 164 and interacts with the fluid discharged therefrom to enhance the formation of the sample plume and the ion release within the plume for sampling by 114b and 116b, e.g., via the interaction of the high speed nebulizing flow and jet of liquid sample (e.g., analyte-solvent dilution). The nebulizer gas can be supplied at a variety of flow rates, for example, in a range from about 0.1 L/min to about 20 L/min, which can also be controlled under the influence of controller 180 (e.g., via opening and/or closing valve 163). In accordance with various aspects of the present teachings, it will be appreciated that the flow rate of the nebulizer gas can be adjusted (e.g., under the influence of controller 180) such that the flow rate of liquid within the sampling probe 51 can be adjusted based, for example, on suction/aspiration force generated by the interaction of the nebulizer gas and the analyte-solvent dilution as it is being discharged from the electrospray electrode 164 (e.g., due to the Venturi effect).

In the depicted embodiment, the ionization chamber 112 can be maintained at an atmospheric pressure, though in some embodiments, the ionization chamber 112 can be evacuated to a pressure lower than atmospheric pressure. The ionization chamber 112, within which the analyte can be ionized as the analyte-solvent dilution is discharged from the electrospray electrode 164, is separated from a gas curtain chamber 114 by a plate 114a having a curtain plate aperture 114b. As shown, a vacuum chamber 116, which houses the mass analyzer 170, is separated from the curtain chamber 114 by a plate 116a having a vacuum chamber sampling orifice 116b. The curtain chamber 114 and vacuum chamber 116 can be maintained at a selected pressure(s) (e.g., the same or different sub-atmospheric pressures, a pressure lower than the ionization chamber) by evacuation through one or more vacuum pump ports 118.

It will also be appreciated by a person skilled in the art and in light of the teachings herein that the mass analyzer 170 can have a variety of configurations. Generally, the mass analyzer 170 is configured to process (e.g., filter, sort, dissociate, detect, etc.) sample ions generated by the ion source 160. By way of non-limiting example, the mass analyzer 170 can be a triple quadrupole mass spectrometer, or any other mass analyzer known in the art and modified in accordance with the teachings herein. Other non-limiting, exemplary mass spectrometer systems that can be modified in accordance various aspects of the systems, devices, and methods disclosed herein can be found, for example, in an article entitled “Product ion scanning using a Q-q-Qₗᵢₙₑₐᵣ ion trap (Q TRAP®) mass spectrometer,” authored by James W. Hager and J. C. Yves Le Blanc and published in Rapid Communications in Mass Spectrometry (2003; 17: 1056-1064), and U.S. Pat. No. 7,923,681, entitled “Collision Cell for Mass Spectrometer,” which are hereby incorporated by reference in their entireties. Other configurations, including but not limited to those described herein and others known to those skilled in the art, can also be utilized in conjunction with the systems, devices, and methods disclosed herein. For instance other suitable mass spectrometers include single quadrupole, triple quadrupole, ToF, trap, and hybrid analyzers. It will further be appreciated that any number of additional elements can be included in the system 110 including, for example, an ion mobility spectrometer (e.g., a differential mobility spectrometer) that is disposed between the ionization chamber 112 and the mass analyzer 170 and is configured to separate ions based on their mobility difference through a drift gas in high- and low-fields rather than their mass-to-charge ratio). Additionally, it will be appreciated that the mass analyzer 170 can comprise a detector that can detect the ions which pass through the analyzer 170 and can, for example, supply a signal indicative of the number of ions per second that are detected.

As discussed above, during the sampling process, the microplate is open to the atmosphere. The solvent evaporation would be a challenge especially for the “in-situ kinetics” workflow where the solution is ejected multiple times from the same well during the incubation process, which could be longer than 30 min and with temperature higher than ambient (e.g. 37° C.).

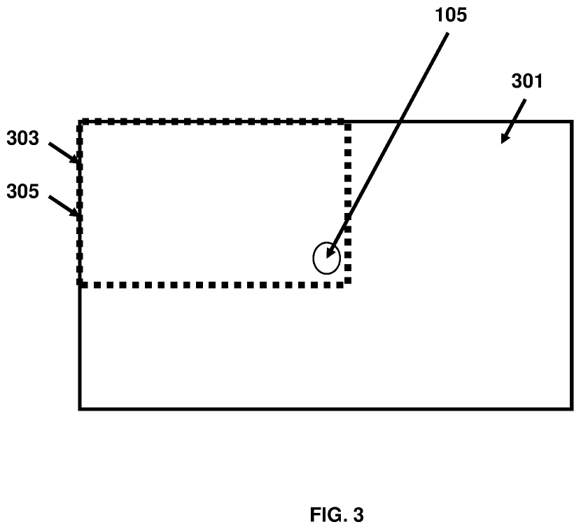

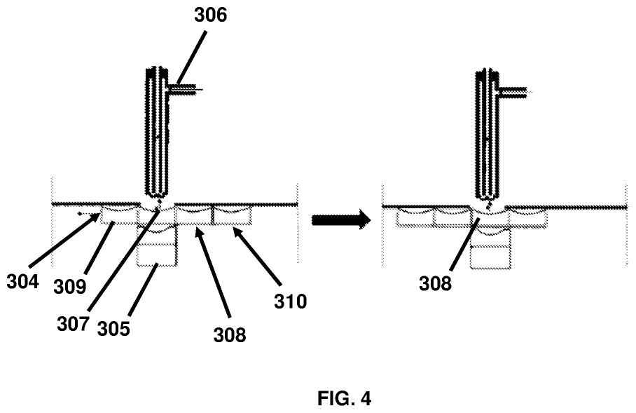

To further decrease evaporation a slip cover could optionally be added. Addition of a slip cover can help to reduce phase change, e.g. evaporation. Embodiments of the present system and method incorporating a slip cover can be seen at FIGS. 3-4. Specifically, FIG. 3 shows a view looking down on the top of an embodiment of the present systems/methods incorporating a slip cover. FIG. 4 shows a cross sectional side view of an embodiment of the present systems/methods incorporating a slip cover during testing of a first well (left image) and second well (right image).

The slip cover 301 can contain at least one sampling hole 302 on the slip cover 301 that permits access to the sample in the well 303 of the microplate 304. In some embodiments, the slip cover 301 may have multiple holes for simultaneous sampling of multiple wells 303 in the microplate 304. Other than the sampling hole or holes 302, the slipcover 301 can otherwise be generally continuous as shown in FIG. 3. The size of the slip cover 301 is large enough so that wells 303 of the microplate 304 are not open to the atmosphere when they are not being sampled/analyzed.

As can be seen in FIGS. 3-4, the slip cover 301 is used in conjunction with a movable stage 305. The microplate 304 is positioned on the movable stage 305. The movable stage 305 can move the microplate 304 relative to the stationary slip-cover 301 with little or no air gap between the slip cover 301 and the top of the microplate 304. As shown in FIGS. 3-4, the well 303 that is being sampled/analyzed can be moved below the sampling hole for an ejection event, e.g. from an ADE 306. The movable stage 305 moves the microplate 304 so that the well 303 being sampled/analyzed aligns with the hole 302 in the slip cover 301.

Specifically, FIG. 4 shows a cross sectional side view of an embodiment of the present systems/methods incorporating a slip cover during testing of a first well 307 (left image) and second well 308 (right image). In the left image, the movable stage 305 aligns the hole 302 in the slip cover 301 with a first well 307 during sampling/analysis of that first well 307. A second well 308 and (other wells 309 and 310) are covered by the slip cover 301 during the sampling analysis of the first well 307. This helps to avoid phase change, e.g. evaporation, from the second well 308 (and others wells 309 and 310) during sampling/analysis of the first well 307. In the second image, the movable stage 305 has moved the microplate 304 such that the hole 302 in the slip cover 301 is aligned with a second well 308 during sampling/analysis of that second well 308. The first well 307 and (other wells 309 and 310) are covered by the slip cover 301 during the sampling analysis of the second well 308. This helps to avoid phase change, e.g. evaporation, from the first well 307 (and others wells 309 and 310) during sampling analysis of the second well 308.

When the system is not sampling any well 303 (e.g., during an incubation period waiting for the next sampling time point), the moveable stage 305 could move the microplate 304 to the position that no wells 303 are aligned with the sampling hole 301.

In some embodiments the slip cover can be made of glass, plastic, etc. The bottom surface of the cover can be specially coating to reduce the vapor/droplet adhesion (reduce/eliminate the cross-contamination). Exemplary coatings include hydrophobic coatings.

In some embodiments, the hole size can be similar with the well size. In other embodiments, the hole size can be smaller than the well size but bigger than the drop size.

The slip cover also assists in allowing for in-situ kinetics application (repeated sampling from the sample well with certain time interval). To reduce the evaporation, the sampling hole could be aligned with the sample well only when it is needed to be ejected. At other time, the sampling hole could be moved to other positions (even without aligning with any wells) while waiting for incubation.

While the foregoing has been described with reference to certain aspects and examples, it will be understood by those skilled in the art that various changes may be made and equivalents may be substituted without departing from the scope of the disclosure. In addition, many modifications may be made to adapt a particular situation or material to the teachings of the disclosure without departing from its scope. Therefore, it is intended that the disclosure not be limited to the particular example(s) disclosed, but that the disclosure will include all examples falling within the scope of the appended claims.

1. A system for chemical analysis of a sample material, comprising:
a sample delivery system;
a sample microplate;
a chemical analyzing component; and
a temperature and humidity control component.

2. The system of claim 1, wherein the sample delivery system comprises an acoustic droplet ejection system.

3. The system of claim 1, wherein the sample delivery system further comprises an open port interface.

4. The system of claim 1, wherein the system comprises a high throughput screening system, a microfluidics system and/or a micro-electromechanical system.

5. The system of claim 1, wherein the chemical analyzing component comprises a chromatography instrument, a mass spectrometer, an ultraviolet-visible spectrometer, a near-infrared spectrometer and/or a fluorescence/illumination detection instrument.

6. The system of claim 1, wherein the temperature and humidity control component comprises a flow of gas.

7. The system of claim 6 wherein, the temperature and humidity control component controls at least one of the flow rate, temperature, humidity and/or atmospheric composition of the gas.

8. The system of claim 5, wherein the gas is at a temperature of above 37° C.

9. The system of claim 1, wherein the temperature and humidity control component is a blower that produces a top down curtain of gas.

10. The system of claim 1, wherein the system allows for same-well reaction monitoring of in-situ kinetics.

11. The system of claim 1, further comprising a slip cover having a hole covering said microplate and a movable stage under said microplate.

12. A method for analyzing a sample material, comprising the steps of:
providing a sample to a sample plate via a sample delivery device;
performing chemical analysis on a sample from the sample plate; and
controlling temperature and humidity during sample delivery and chemical analysis.

13. The method of claim 12, wherein the sample delivery device comprises an acoustic droplet ejection system.

14. The method of claim 12, further wherein the sample delivery device further comprises an open port interface.

15. The method of fief claim 12, wherein the method comprises high throughput screening, microfluidics testing and/or micro-electromechanical testing.

16. The method of claim 12, wherein the chemical analysis is at least one selected from the group consisting of chromatography, mass spectrometry, ultraviolet-visible spectrometry, near-infrared spectrometry, and/or fluorescence/illumination detection.

17. The method of claim 12, wherein the temperature and humidity are controlled using a flow of gas.

18. The method of claim 17 wherein, the temperature and humidity are controlled using at least one of the flow rate, temperature, humidity and/or atmospheric composition of the gas.

19. The method of claim 17, wherein the gas is at a temperature of above 37° C.

20. The method of claim 12, wherein the temperature and humidity is controlled using a blower that produces a top down curtain of gas.

21. The method of claim 12, wherein the method monitors in-situ kinetics of same-well reactions.

22. The method of claim 12, further comprising covering said microplate with a slip cover having a hole and moving said microplate to align said hole with a well being analyzed.

23. A temperature and humidity control component for use in analyzing a sample material, comprising a blower for producing a top down curtain of humidified gas at a temperature of greater than 37° C.
